(19) United States
(12) Patent Application Publication
(10) Pub. No.: US 2025/0306207 A1
(43) Pub. Date: Oct. 2, 2025

(54) SWITCH-BASED PHOTONIC INTEGRATED CIRCUIT ARCHITECTURES FOR MULTI-POINT SENSING APPLICATIONS

(71) Applicant: Intel Corporation, Santa Clara, CA (US)

(72) Inventors: Jacob Levy, Sierra Madre, CA (US); Amit Mizrahi, San Jose, CA (US); Marcus Yang, San Jose, CA (US); Wenhua Lin, Fremont, CA (US)

(73) Assignee: Intel Corporation, Santa Clara, CA (US)

(21) Appl. No.: 18/621,811

(22) Filed: Mar. 29, 2024

(51) Int. Cl. G01S 17/34; G02F 1/21; G02F 1/225

(52) U.S. Cl. CPC G01S 17/34; G02F 1/212; G02F 1/225

(57) ABSTRACT

Photonic integrated circuit (PIC) transceiver suitable for use in frequency modulated continuous wave (FMCW) reflectometry applications where an array of output beams is generated by optically switching a continuous wave laser source across an array of output couplers. An optical switch, for example comprising a cascade of Mach-Zehnder interferometers (MZI) may be coupled between the output couplers and a receiver. Accordingly, elements of the receiver need not be replicated 1:1 with the output couplers.

### BACKGROUND

Photonic integrated circuits (PIC) are promising platforms for sensing applications where an array of M emitted beams are launched from transmitter elements of the PIC at various directions in the far field and reflections returned to receiver elements of the PIC are analyzed, for example to generate a spatial map. A PIC-based implementation of photonic sensors based on frequency modulated continuous wave (FMCW) reflectometry may interrogate multiple spatial points through a combination of multiple emission (output) ports, the use of multiple wavelengths in conjunction with a diffraction element, integrated solid state beam steering or an external beam steering element.

Photonic sensing architectures may rely on a single laser or multiple lasers illuminating across multiple emission ports. As the number of output ports M increases and/or the number of lasers N increases, the size and complexity of a photonic integrated circuit (PIC) implementing the sensor also increases. A PIC-based sensing application comprising an N×M emitter array in which N lasers serve M arrayed output elements, for example sequentially, may face challenges meeting constraints in device size, cost, reliability, and/or yield so that a maximum number (N×M) of elements limits functionality of the PIC.

Optical transmission techniques and PIC architectures capable of generating a given far field spot count with smaller transceiver (TRX) form factors and/or lower cost are therefore commercially advantageous.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIGS. 1A, 1B and 1C are schematics of a photonic integrated circuit (PIC) transceiver (TRX) architecture including a photonic emitter switch in three different time divided states, in accordance with some embodiments;

FIG. 2 is a schematic of the PIC TRX architecture further illustrating an emitter switch architecture, in accordance with some embodiments;

FIG. 3A and FIG. 3B are cross-sectional profiles of planar photonic waveguides suitable for the emitter switch illustrated in FIG. 2, in accordance with some embodiments;

FIG. 4 is a schematic of the PIC TRX architecture illustrated in FIG. 2 expanded to support a greater number of emitter ports, in accordance with some embodiments;

FIG. 5 is a schematic of the PIC TRX architecture illustrated in FIG. 2 expanded to support laser redundancy, in accordance with some embodiments;

FIG. 6 is a schematic of a PIC TRX architecture including a photonic source switch, in accordance with some embodiments;

FIG. 7 is a schematic of a PIC TRX architecture including the source switch introduced in FIG. 6 and the emitter switch introduced in FIG. 2, in accordance with some embodiments;

FIG. 8 is a schematic of a broadband PIC TRX architecture incorporating the emitter switch introduced in FIG. 2 with wavelength multiplexing at each emitter port, in accordance with some embodiments;

FIG. 9 is a functional block diagram of an electronic computing device, that may implement one or more of the components of a PIC-based FMCW reflectometry system, in accordance with some embodiments.

### DETAILED DESCRIPTION

Embodiments are described with reference to the enclosed figures. While specific configurations and arrangements are depicted and discussed in detail, this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that embodiments may be practiced without these specific details. In some instances, well-known methods and devices are shown in block diagram form, rather than in detail, to avoid obscuring the embodiments. Reference throughout this specification to “an embodiment” or “one embodiment” or “some embodiments” means that a particular feature, structure, function, or characteristic described in connection with the embodiment is included in at least one embodiment. Thus, the appearances of the phrase “in an embodiment” or “in one embodiment” or “some embodiments” in various places throughout this specification are not necessarily referring to the same embodiment. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause-and-effect relationship).

The terms “over,” “under,” “between,” and “on” as used herein refer to a relative position of one component or material with respect to other components or materials where such physical relationships are noteworthy. For example, in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer is in direct contact with that second material/layer. Similar distinctions are to be made in the context of component assemblies.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

A PIC FMCW reflectometry system may advantageously comprise a transmitter (TX) with a single wavelength (channel) or multi-wavelength source. As described further below, a PIC FMCW reflectometry system may comprise a photonic output port (emitter) switch network to optically couple a given laser source to a plurality of output couplers, which may couple the beams to any downstream optical elements that are further operable to illuminate a plurality of far field spots. The switch network may implement any desired time division algorithm to alternate which output port a FMCW beam exits at any instant in time. With the emitter switch network, fewer laser sources are needed for a system a given number of emitters. For exemplary embodiments, the emitter switch network is polarization independent (i.e., diverse), improving scalability of a receiver (RX) comprising N×M mixing elements, such as a local oscillator (LO) tap, polarization beam splitter and rotator (PBSR), coherent mixer, and balanced photodetector (BPD). Accordingly, embodiments herein may significantly reduce optical component count and size of a PIC FMCW reflectometer of a particular N×M rating or enable a larger N×M rating for a particular PIC size and cost.

In accordance with exemplary embodiments, PIC FMCW reflectometer architectures are advantageously implemented with one or more silicon photonic (SiPh) chips (that may also include III-V semiconductor material). Although examples herein are therefore further described in the context of SiPh implementations, the exemplary PIC FMCW reflectometer architectures may also be implemented in alternative technologies without departing from the principles disclosed herein.

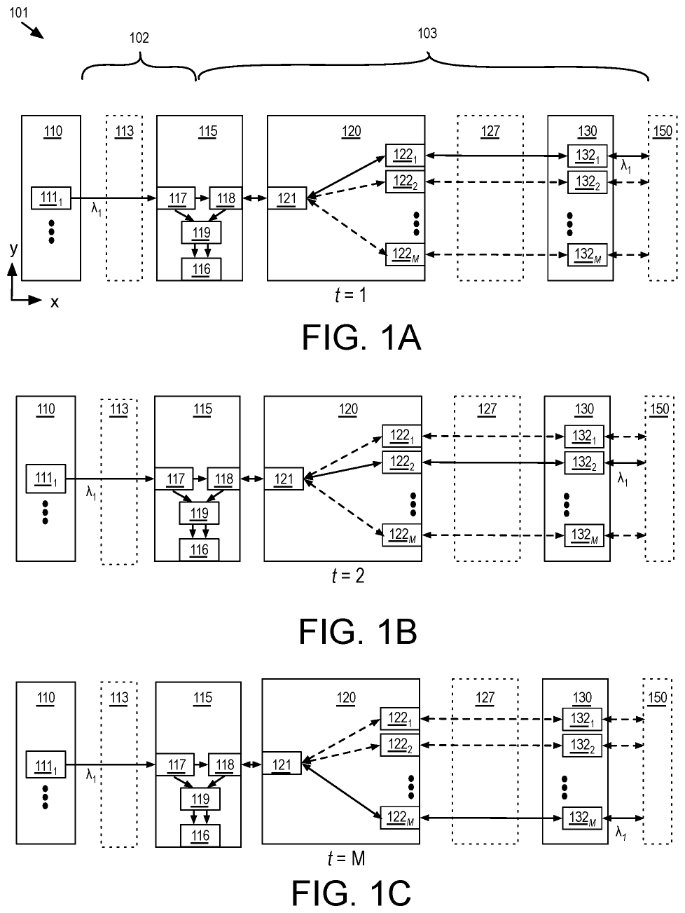

FIGS. 1A, 1B and 1C are schematics of a photonic integrated circuit (PIC) transceiver (TRX) architecture 101 including a photonic emitter switch network 120 in three different time divided states. PIC TRX architecture 101 may implement a FMCW reflectometer, in accordance with some embodiments. Generally, architecture 101 is plan or layout view having some correspondence to physical area of a PIC die implementing the architecture. FIG. 1A illustrates a first state of architecture 101 at a first exemplary time instant (e.g., t=1). FIG. 1B illustrates a second state of architecture 101 at a second exemplary time instant (e.g., t=2) and FIG. 1C illustrates a third state of architecture 101 at a third exemplary time instant (e.g., t=M). Three states are illustrated for clarity of discussion. However, in practice, architecture 101 may have any number of states as a function of parameters of the specific switch implementation. For example, an emitter switch network may have as many different switch states as possible for a particular laser source power and a particular transceiver frame rate.

PIC TRX architecture 101 comprises exclusively transmitter elements 102 that need only propagate the TE mode, and transceiver elements 103 that are to propagate both transmitter TE modes and reflected TM modes. Transmitter elements 102 include an optical beam source 110 that may be optically coupled to any number of passive or active optical elements 113, which are drawn in dashed line to emphasize such elements are optional. Transceiver elements 103 include a receiver 115 optically coupled to an emitter switch network 120. Switch network 120 is optically coupled to output coupler (emitter) array 130 through any number of intervening passive or active optical elements 127, again drawn in dashed line to emphasize such elements are optional. Output coupler array 130 may be a 2D surface emitting staring array, or an array of edge emitters, for example. Output coupler array 130 may output to any downstream optical element(s) 150 suitable for a particular application. For example, optical elements 150 may include a dispersive element (e.g., a diffractive grating) and/or one or more lenses suitable for spot size conversion, etc.

One or more of source 110, receiver 115, switch network 120, and output coupler array 130 may be implemented in a SiPh chip. In some advantageous embodiments, switch network 120 and output coupler array 130, as well as any intervening optical elements 127, are all implemented in a single (e.g., first) SiPh chip. In exemplary embodiments, source 110 is implemented in the same SiPh chip as switch network 120. However, in some multi-chip implementations, switch network 120, output coupler array 130 and receiver 115 are implemented in a first PIC while source 110 is implemented in a second PIC chip. Optical elements 150 may be implemented on a PIC chip, or off-chip.

In the embodiment depicted in FIG. 1A-1C, source 110 comprises a laser 111₁ operable at a center channel wavelength λ₁. In some examples, channel wavelength λ₁ is within the O-band (i.e., 1260-1360 nm) or C-band (i.e., 1530-1565 nm) of the electromagnetic spectrum. However, wavelength λ₁ may fall within another band, particularly where architecture 101 is implemented in an alternative to a SiPh chip that enables wavelengths shorter than those suitable for silicon. Laser 111₁ is advantageously a laser diode operable in a continuous-wave (CW) emission mode, such as a distributed-feedback (DFB) laser or an external cavity laser. In exemplary embodiments, laser 111₁ emits at a power of around 10 dbm, or more. In further embodiments, laser 111₁ is frequency modulated (FM), or chirped. A frequency modulated continuous wave (FMCW) source may be modulated, for example, such that frequency as a function of time defines an approximately triangular waveform. The frequency range of one modulation period may vary with application, for example to be below or above 1 GHz. Laser emission may be direct modulated (e.g., through control of current injection), or indirectly modulated (e.g., through a Mach-Zehnder modulator implemented as one of optical elements 113).

As shown, laser 111₁ is optically coupled into receiver 115. Receiver 115 includes a local oscillator tap 117, which may be any known optical splitter where most optical power (e.g., a 90:10 splitting ratio, etc.) is a transmitted portion further propagated through a polarization beam splitter and rotator 118 into switch input port 121. Reflected optical power (represented in the figures as an arrowhead pointing in the negative x-axis) collected by output coupler array 130 is propagated with TM polarization through emitter switch 120 to receiver 115. PBSR 118 extracts and rotates the reflected TM mode(s) which is coupled, along with the LO portion of optical power from laser 111₁, into a coherent mixer 119. Coherent mixer 119 may be, for example, a 2×2 multi-mode interferometer (MMI). A pair of output ports from mixer 119 are coupled to a detector pair in a balanced photodetector (BPD) 116 where a beat frequency is generated in the electrical domain. Depending on the application, range and/or other parameters may then be determined, for example with CMOS circuitry (not depicted).

In exemplary SiPh IC embodiments, laser 111₁ is optically coupled to input port 121 through on-chip planar optical waveguides. Switch network 120 comprises one or more optical switches arranged in any manner suitable for coupling input port 121 to each of M optical switch output ports 122. In some embodiments, switch network 120 implements an 1×M non-blocking optical switch whereby input port 121 can be selectably and/or switchably routed or coupled to each of output ports 122₁-122_{M}.

In FIG. 1A, solid lines between input port 121 and output ports 122₁-122_{M} represent an active optical path at time instant t=1. Dashed lines between input port 121 and output ports 122₁-122_{M} represent alternative optical paths that are inactive at time instant t=1. Hence, at time t=1, switch input port 121 is optically coupled to switch output port 122₁.

Switch output ports 122₁-122_{M} are each optically coupled, optionally through one or more optical elements 127, to a corresponding output coupler 132 of array 130. As illustrated, output coupler array 130 comprises a plural number M of output couplers (i.e., emitters) 132₁-132_{M}. The number M may vary with implementation (e.g., ranging from 2 to 64, or more). In exemplary SiPh IC embodiments, switch output ports 122₁-122_{M} are optically coupled to output couplers 132₁-132_{M} through one or more on-chip planar optical waveguides. For such embodiments, each output coupler 132₁-132_{M} advantageously comprises an edge coupler (EC) but may alternatively comprise a grating coupler (GC) or a total internal reflection (TIR) mirror, for example. Output couplers 132 may further comprise a spot-size convertor, such as any known to be suitable for expanding an optical mode from dimensions of a single mode planar waveguide to a mode size of any downstream optical element 150.

With switch network in a first state at a first time instant (t=1), an optical beam of wavelength λ₁ is routed to output coupler 132₁, for example where it is emitted off-chip. During operation, switch network 120 is to route optical beams from laser 111₁ to alternating output ports 122₁-122_{M} in a time divided manner, thereby modulating which of output couplers 132₁-132_{M} emit a beam. Over time, therefore, wavelength λ₁ is emitted from each of output couplers 132₁-132_{M}. FIG. 1B, for example, depicts switch network 120 in a second state at another time instant (t=2) where the optical beam of wavelength λ₁ is coupled to switch output port 122₂. Accordingly, this beam is now emitted from output coupler 132₂. In a third state illustrated in FIG. 1C, switch network 120 during another time instant (t=M) couples the optical beam of wavelength λ₁ to switch output port 122_{M} and output coupler 132_{M}. Although only three states are illustrated by FIG. 1A-1C, switch network 120 may similarly transition between M different states with each of the M states routing through M different output couplers.

Switch network state transitions may be according to any scheduling algorithm, such as a round-robin or other circular queue. In some exemplary embodiments, the duration that wavelength λ₁ is emitted from each of output couplers 132₁-132_{M} is time averaged to be approximately equal across all wavelengths.

Emitter switch network 120 reduces the optical element count of receiver 115. For the illustrated embodiments, emitter switch network 120 reduces an element count that includes tap coupler 117, PBSR 118, coherent mixer 119 and BPD 116 from M to 1. This receiver component count reduction corresponds to a significant reduction in PIC die size and a direct cost reduction. For an exemplary embodiment where M=4, a 1×4 2D staring array implementation may have ˜70% component count reduction relative to an architecture lacking an emitter switch network and instead comprising 4 instances of the optical elements illustrated for receiver 115. As further described below, for embodiments with a multiplicity of laser sources (e.g., N sources), an N×M architecture will benefit from an even greater reduction in component count and corresponding PIC die size reduction.

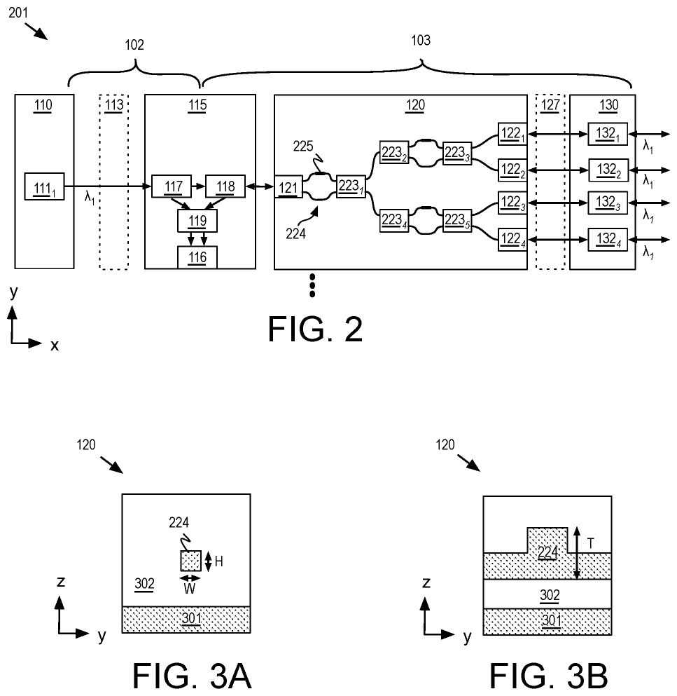

Polarization independent or insensitive switches can be designed and implemented based on Mach-Zehnder interferometer (MZI) filter structures, for example. FIG. 2 is a schematic of a PIC TRX architecture 201 further illustrating a polarization independent switch architecture, in accordance with some 1×4 embodiments comprising a cascaded Mach-Zehnder interferometer (CMZI) filter structure. CMZI filter structures offer low insertion loss and polarization diversity. As shown in FIG. 2, switch input port 121 is a 1×2 MMI coupled into a 2×2 MMI 223₁ through two optical waveguide paths (arms) 224 of a first imbalanced MZI stage. Each MMI may have any suitable splitting ratio. Output ports of MMI 223₁ are each cascaded to a serial second imbalanced MZI stage. Within the second stage, an input 2×2 MMI 223₂ is coupled to an output 2×2 MMI 223₃ and an input 2×2 MMI 223₄ is coupled to an output 2×2 MMI 223₅, each through a pair of imbalanced optical waveguide paths. Output ports of MMI 223₃ and MMI 223₅ are coupled to switch output ports 122₁-122₄. In alternative embodiments, switch network 120 may comprise 1×2 and 2×2 directional couplers instead of MMI designed to be similarly polarization independent.

The transmission function of a CMZI filter is a function of the differential path lengths of the two optical waveguide paths (arms) of the MZIs in each stage. Electrical circuits controlling one or more resistive heaters 225 thermally coupled to the arms of the CMZI structures enable filter tuning through the thermo-optic effect to modulate the phase difference of the two arms of each stage. Optical phase control of each MZI switch is proportional to an arm length difference (ΔL). The differential length ΔL induces an incremental phase shift, which may vary (e.g., π/4, π/2, π, etc.) according to design. For example, the change in phase/heater power of a switch stage with twice ΔL is approximately twice the change in phase/heater power of a switch stage with ΔL.

Photonic waveguides 224 are polarization insensitive to support propagation of TE and TM polarized light through optical switch network 120. Two primary waveguide design considerations are waveguide core geometry and waveguide core material system. FIG. 3A and FIG. 3B illustrate cross-sectional profiles of planar photonic waveguides in accordance with two exemplary embodiments that are compatible with many SiPh processes.

In FIGS. 3A and 3B, PIC substrate 301 may have any composition suitable for the fabrication of planar optical waveguides 224. In advantageous embodiments, substrate 301 comprises one or more layers of silicon. Substrate 301 may include a device material layer of substantially pure monocrystalline silicon. In exemplary embodiments where the device material layer is substantially pure silicon, insulator material 302 is advantageously predominantly silicon and oxygen (e.g., SiO₂). One or more additional substrate material layers may be under, or on a back side of, the insulator material layer as mechanical support. Substrate 301 may alternatively include other materials, such as a monolithic glass layer.

FIG. 3A illustrates quasi-square waveguide core embodiments where waveguide 224 has a sidewall height H that is substantially equal (e.g., within 10%) to a transverse waveguide width W. The quasi-square waveguide core with approximately same core width and height supports both fundamental transverse electric (TE₀₀) and fundamental transverse magnetic (TM₀₀) polarizations with approximately equal effective refractive indexes (e.g., less than 10⁻³ index difference). Waveguide sidewall height H (and width W) may vary as a function of core composition with height H being less than 1.5 μm for exemplary silicon cores and less than 3 μm for exemplary cores comprising predominantly silicon and nitrogen (e.g., Si₃N₄). For silicon core embodiments, waveguides 224 may be defined from at least a portion of a silicon device material layer, which in some embodiments is a top layer of a semiconductor-on-insulator (SOI) substrate material stack further comprising insulator material layer 302. Rib-to-channel mode converters may be utilized to convert from the channel waveguide core to a rib waveguide core (and vice versa), for example where transmitter portion 102 comprises rib waveguide cores.

FIG. 3B illustrates an alternative thick single mode rib waveguide core where waveguide thickness T is at least 1.5 μm for silicon core embodiments and at least 4 μm thick Si₃N₄ core embodiments. Such waveguides are also polarization insensitive, again typically having TE/TM refractive index differences that are less than 1×10⁻³. Accordingly, waveguides 224, as well as MMI 223₁-223₅ may also comprise thick rib waveguide cores.

In some embodiments, optional optical elements 113 between source 110 and receiver 115 comprise one or more directional splitters/couplers to fanout emitter switch 120 (e.g., the 1×4 CMZI architecture illustrated in FIG. 2) across a larger number of M output couplers or to introduce laser redundancy.

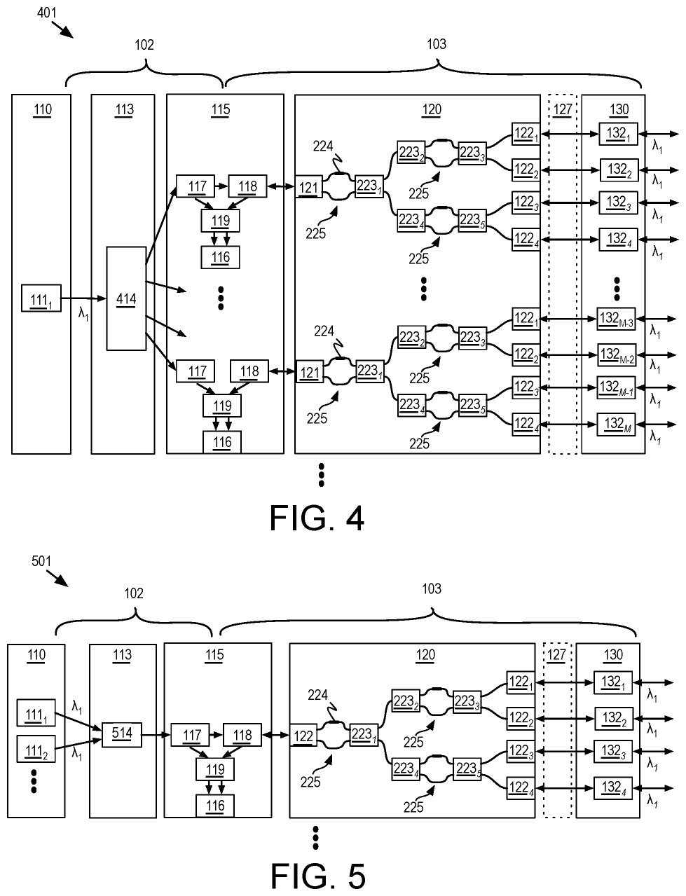

FIG. 4 is a schematic of a PIC TRX architecture 401, in accordance with some embodiments where source laser 111₁ is coupled into an optical splitter 414. Depending on the split ratio, optical splitter 414 may have any number N output ports, each of which is coupled into an individual receiver block that further includes LO tap 117, PBSR 118, coherent mixer 119 and BPD 116. As further illustrated, emitter switch 120 includes a fanout of the 1:4 switch architecture described above, which is matched 1:1 with the receiver block fanout. Optical splitter 414 may have any split ratio, for example limited by optical power loss constraints of a particular PIC application. In the illustrated embodiment, splitter 414 has 1:4 split ratio and may be implemented by a 1×4 MMI. Alternatively, splitter 414 may comprise multiple 1:2 MMI or directional coupler stages. Optical elements 113 may also comprise one or more optical gain stages. The number of optical gain stages may vary, for example as a function of the splitting ratio of optical splitter 414 and/or the output power of laser 111₁, and/or the far field parameters associated with a particular FMCW reflectometry application. An optical gain stage may be of any suitable architecture. In some exemplary embodiments, a single gain stage includes a semiconductor optical amplifier (SOA) comprising any suitable gain medium and/or pumping architecture.

FIG. 5 is a schematic of a PIC TRX architecture 501 supporting laser redundancy, in accordance with some embodiments. As shown, architecture 501 includes the PIC TRX architecture 201. However, source 110 further includes a second CW laser 111₂, which also emits at wavelength λ₁. In exemplary embodiments, lasers 111₁ and 111₂ are substantially identical and each is coupled into a 2:1 directional coupler 514 that has an output port coupled into LO tap 117. In operation, only one of lasers 111₁ and 111₂ is operable (in CW mode) at a given time. If one laser (e.g., laser 111₁) becomes damaged during an operational lifetime, another (e.g., laser 111₂) may be placed into an operable state, for example to improve PIC reliability and/or extend PIC lifetime. PIC embodiments including redundant lasers 111₁ and 111₂ may also achieve higher manufacturing yields, for example with a second laser overcoming a manufacturing defect that prevents operation of a first laser.

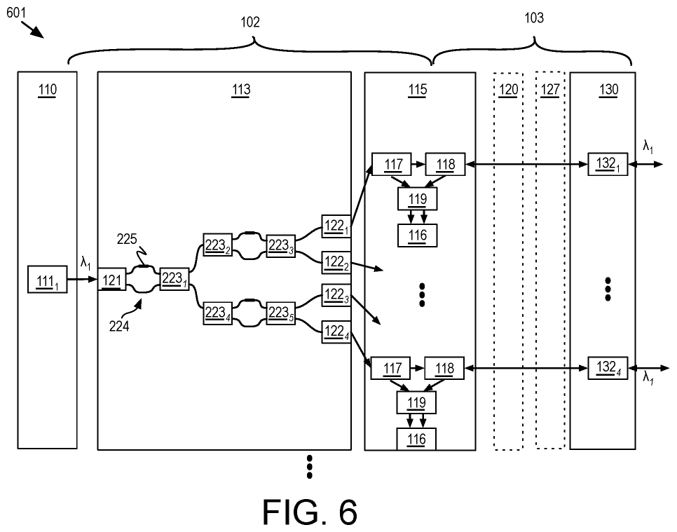

In some alternative embodiments, optical elements 113 comprise an active source switch. The source switch may, in some examples, cycle a laser source through different banks of receivers and output couplers. FIG. 6 is a schematic of an exemplary PIC TRX architecture 601 where optical elements 113 implement a photonic source switch comprising a 1:4 CMZI filter structure. Because optical elements 113 are within the transmitter portion 102, the CMZI filter structure of architecture 601 need not have polarization diversity. For example, waveguides 224 need not have the same design constraints as those of the CMZI filter introduced in architecture 201 (FIG. 2). In FIG. 6, switch input port 121 is a 1×2 MMI coupled into a 2×2 MMI 223₁ through two optical waveguide paths (arms) 224 of a first MZI stage. Output ports of MMI 223₁ are each cascaded to a serial second MZI stage. Within the second stage, an input 2×2 MMI 223₂ is coupled to an output 2×2 MMI 223₃ and an input 2×2 MMI 223₄ is coupled to an output 2×2 MMI 223₅, each through a pair of optical waveguide paths. Each MMI may have any suitable splitting ratio. Output ports of MMI 223₃ and MMI 223₅ are coupled to switch output ports 122₁-122₄. Each of switch output ports 122₁-122₄ is optically coupled into an LO tap 117 in one of a plurality of receiver blocks. Accordingly, scalability of output couplers 132 may be limited due to the area (footprint) of the elements replicated within receiver 115.

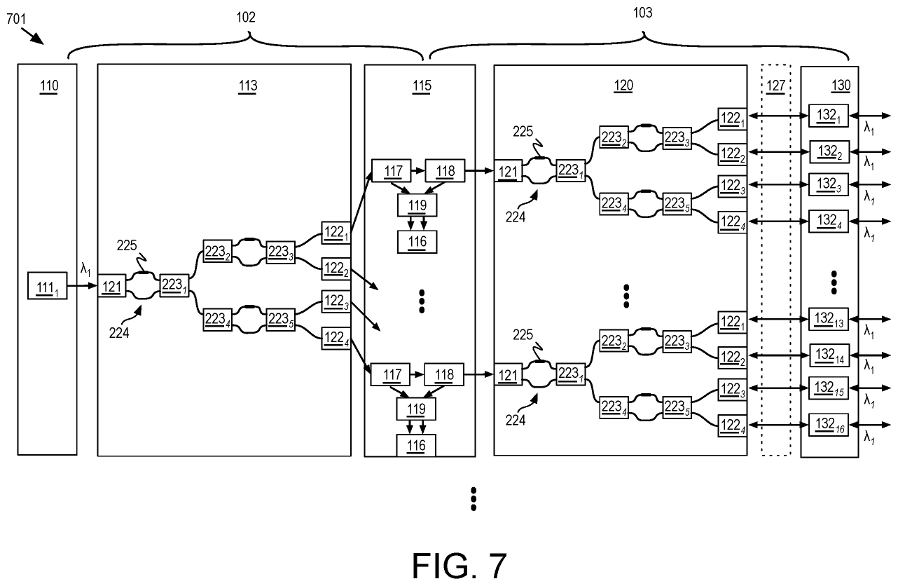

FIG. 7 is a schematic of a PIC TRX architecture 701 including the source switch introduced architecture 601 (FIG. 6) and the emitter switch introduced in architecture 201 (FIG. 2), in accordance with some embodiments that address emitter scalability issues. In architecture 701 (FIG. 7), optical elements 113 comprise a first CMZI, which in the illustrated example implements a 1:4 source switch, for example substantially as described above. Receiver 115 includes four receiver blocks, for example substantially as described above. Each receiver block is further coupled to a 1:4 emitter switch, for example substantially as described above. Architecture 701 therefore supports sixteen output couplers 132₁-132₁₆.

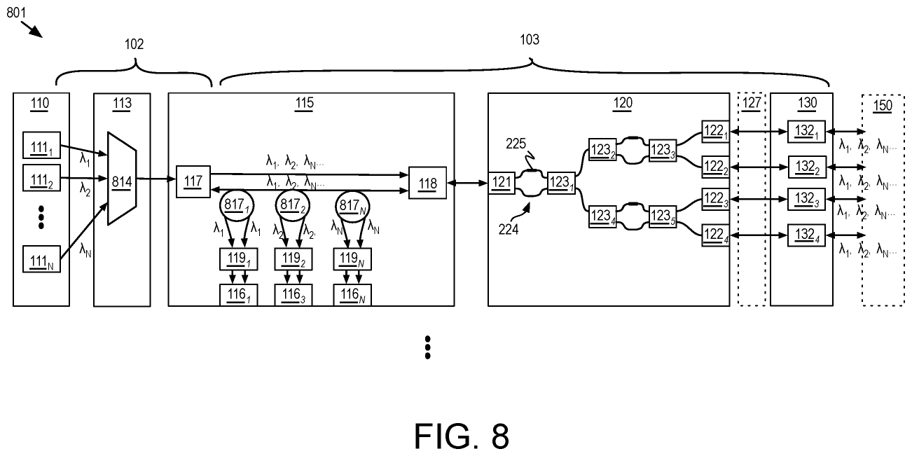

Although the above embodiments have been described in the context of narrow bandwidth applications, structural aspects illustrated are readily adaptable to wide bandwidth applications that further rely on wavelength division multiplexing. FIG. 8 is a schematic of a broadband PIC TRX architecture 801 incorporating the emitter switch introduced above (e.g., FIG. 2) with wavelength multiplexing at each emitter port.

In FMCW reflectometry applications, multiple wavelengths in combination with a dispersive element (e.g., within optical elements 150) multiply the points in space that each output coupler 132₁-132₄ covers by a number of N wavelengths multiplexed because each wavelength will be deflected to a slightly different point in space determined by free space optics coupled to the PIC. Alternatively, each of output couplers 132₁-132₄ could be an integrated grating coupler with wavelength dependent diffraction angles. In architecture 801, source 110 comprises N lasers 111₁-111_{N}, which may all be operable within any of the bands listed above for laser 111₁. Each laser 111₁-111_{N} is coupled into an input port of a fixed wavelength planar light circuit (PLC) multiplexer 814. Multiplexer 814 may comprise an N:1 AWG or an echelle grating, for example.

An output port of multiplexer 814 is coupled, for example through a planar single-mode waveguide, to a same LO tap coupler 117, PBSR 118 and emitter switch 120 because each of these elements is suitable for broadband propagation. For such wavelength division multiplexed embodiments, the rate at which emitter switch 120 can cycle through output couplers 132₁-132₄ while ensuring reflected signals are passed back to receiver 115 may define an upper limit on sensor frame rate.

For the return path(s) depicted in FIG. 8 by leftward pointing arrows, the local oscillator signal for each wavelength λ₁-λ_{N} is dropped to one mixer 119₁-119_{N} and corresponding BPD 116₁-116_{N} by a demux ring resonator network comprising tuned resonant add/drop ring waveguide filters 817₁-817_{N}, which are tuned for a given center wavelength λ₁-λ_{N}. For FMCW reflectometry systems benefitting more from additional output couplers than from additional laser sources, architecture 801 advantageously reduces the number of BPDs 116 and coherent mixers 119 to only a single one for each of N center wavelengths. Furthermore, architecture 801 needs only the single PBSR 118 and single LO tap 117. For systems benefitting from multiple wavelengths (e.g., to increase frame density), architecture 801 enables sensing of multiple wavelengths simultaneously for an increased frame rate, or alternatively, an increased sensitivity for a same frame rate.

Architecture 801 may be scaled to have additional output couplers 132 (i.e., emitters) in a manner similar to architecture 201 (FIG. 2), for example by adding optical splitters (and amplifiers) at the output of multiplexer 814. Similar to architecture 401 (FIG. 4), such embodiments may further include multiple receiver blocks, each of which includes a replication of LO tap 117, PBSR 118 and demux networks 817₁-817_{N}, etc. Likewise, emitter switch 120 may be replicated to support the greater number of output couplers 132.

FMCW reflectometry PIC TRX architectures in accordance with embodiments herein may be implemented within a wide variety of platforms, including consumer electronics such as virtual reality (VR) headsets, where system cost is a significant factor. In some other examples, PIC FMCW reflectometry TRX architectures in accordance with embodiments herein may be integrated into commercial devices, such as security sensor networks, where a large staring array is a priority over a high frame rate. The architectures described herein also enable continuous operation of a laser, which is advantageous over switched laser operation that introduces significant challenges with respect to laser frequency stabilization.

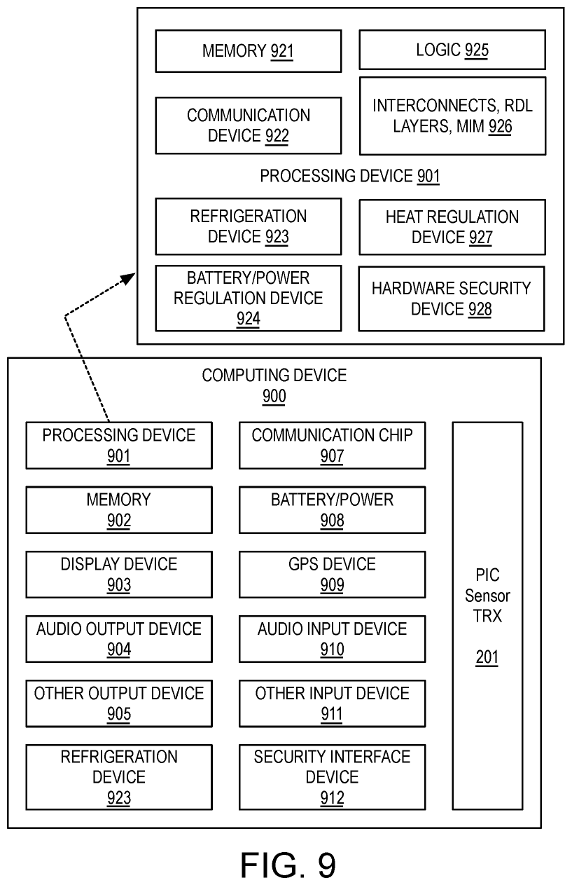

FIG. 9 is a functional block diagram of an electronic computing device 900, that may implement one or more of the components of a FMCW reflectometry system, in accordance with some embodiments. Computing device 900 may include any of the PIC TRX architectures discussed elsewhere herein. A number of components are illustrated in FIG. 9 as included in computing device 900, but any one or more of these components may be omitted or duplicated, as suitable for the application. In some embodiments, some of the components included in computing device 900 may be attached to one or more printed circuit boards (e.g., a motherboard). In some embodiments, various ones of these components may be fabricated onto a single system-on-a-chip (SoC) die or implemented with a disintegrated plurality of chiplets or tiles co-packaged together. Additionally, in various embodiments, computing device 900 may not include one or more of the components illustrated in FIG. 9, but computing device 900 may include interface circuitry for coupling to the one or more components. For example, computing device 900 may not include a display device 903, but may include display device interface circuitry (e.g., a connector and driver circuitry) to which display device 903 may be coupled.

Computing device 900 may include a processing device 901 (e.g., one or more processing devices). As used herein, the term processing device or processor indicates a device that processes electronic data from registers and/or memory to transform that electronic data into other electronic data that may be stored in registers and/or memory. Processing device 901 may include a memory 921, a communication device 922, a refrigeration/active cooling device 923, a battery/power regulation device 924, logic 925, interconnects 926, a heat regulation device 927, and a hardware security device 928.

Processing device 901 may include one or more digital signal processors (DSPs), application-specific integrated circuits (ASICs), central processing units (CPUs), graphics processing units (GPUs), field programmable gate array (FPGA), or any other suitable processing devices suitable as a reflectometer controller.

Processing device 901 may include a memory 902, which may itself include one or more memory devices such as volatile memory (e.g., dynamic random-access memory (DRAM)), nonvolatile memory (e.g., read-only memory (ROM)), flash memory, solid state memory, and/or a hard drive. In some embodiments, processing device 901 shares a package with memory 902. This memory may be used as cache memory and may include embedded dynamic random-access memory (eDRAM) or spin transfer torque magnetic random-access memory (STT-M RAM).

Computing device 900 may include a heat regulation/refrigeration device 923. Heat regulation/refrigeration device 923 may maintain processing device 901 (and/or other components of computing device 900) at a predetermined low temperature during operation. This predetermined low temperature may be any temperature discussed elsewhere herein.

In some embodiments, computing device 900 may include a communication chip 907 (e.g., one or more communication chips). For example, the communication chip 907 may be configured for managing wireless and/or optical communications for the transfer of data to and from computing device 900. The term “wireless” and its derivatives may be used to describe circuits, devices, systems, methods, techniques, communications channels, etc., that may communicate data through the use of modulated electromagnetic radiation through a nonsolid medium. Communication chip 907 may implement any of a number of wireless and/or optical standards or protocols.

Computing device 900 includes PIC TRX architecture 201 to enable optical far field interrogation. Computing device 900 may similar include any of PIC TRX architectures 401-801, substantially as described elsewhere herein.

Computing device 900 may include battery/power circuitry 908. Battery/power circuitry 908 may include one or more energy storage devices (e.g., batteries or capacitors) and/or circuitry for coupling components of computing device 900 to an energy source separate from computing device 900 (e.g., AC line power).

Computing device 900 may include a display device 903 (or corresponding interface circuitry, as discussed above). Display device 903 may include any visual indicators, such as a heads-up display, a computer monitor, a projector, a touchscreen display, a liquid crystal display (LCD), a light-emitting diode display, or a flat panel display, for example.

Computing device 900 may include an audio output device 904 (or corresponding interface circuitry, as discussed above). Audio output device 904 may include any device that generates an audible indicator, such as speakers, headsets, or earbuds, for example.

Computing device 900 may include an audio input device 910 (or corresponding interface circuitry, as discussed above). Audio input device 910 may include any device that generates a signal representative of a sound, such as microphones, microphone arrays, or digital instruments (e.g., instruments having a musical instrument digital interface (MIDI) output).

Computing device 900 may include a global positioning system (GPS) device 909 (or corresponding interface circuitry, as discussed above). GPS device 909 may be in communication with a satellite-based system and may receive a location of computing device 900.

Computing device 900 may include another output device 905 (or corresponding interface circuitry, as discussed above). Examples include an audio codec, a video codec, a printer, a wired or wireless transmitter for providing information to other devices, or an additional storage device.

Computing device 900 may include another input device 911 (or corresponding interface circuitry, as discussed above). Examples may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 900 may include a security interface device 912. Security interface device 912 may include any device that provides security measures for computing device 900 such as intrusion detection, biometric validation, security encode or decode, managing access lists, malware detection, or spyware detection.

Computing device 900, or a subset of its components, may have any appropriate form factor, such as a hand-held or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

One or more photonic integrated circuits (PICs), comprising a laser source to output a beam, a plurality of optical output couplers, each of the output couplers to propagate the beam off the PIC and to collect optical power reflected back to the PIC, a receiver to detect the reflected optical power, and an optical switch network coupled between the output couplers and the receiver. The optical switch network comprise a plurality of first ports, each of the first ports optically coupled to one of the output couplers, and a second port optically coupled to the receiver. The switch network is to optically couple each of the first ports to the second port in a time divided manner.

In second examples, for any of the first examples the optical switch network comprises a cascaded Mach-Zehnder interferometer (CMZI) structure comprising a first MZI structure in serial cascade with a second MZI structure.

In third examples, for any of the second examples the first and second MZI structures comprise polarization independent optical waveguides.

In fourth examples, for any of the first through third examples the receiver comprises a polarization splitter coupled to the second port.

In fifth examples, for any of the fourth examples the receiver comprises a local oscillator tap coupled between the polarization splitter and the laser source, a coherent mixer coupled to an output of the local oscillator tap and an output of the polarization splitter, and a balanced photodetector coupled to an output of the coherent mixer.

In sixth examples, for any of the fifth examples the receiver comprises a single polarization splitter and a single local oscillator tap.

In seventh examples, for any of the sixth examples the beam comprises a plurality of center wavelengths, and wherein the receiver comprises a plurality of resonant ring filters, each tuned to a different one of the plurality of center wavelengths.

In eighth examples, for any of the first through seventh examples the plurality of output couplers comprises N sets of M output couplers and N and M are each an integer number greater than one, the optical switch network comprises N 1:M switches, and the PIC further comprises a 1:N optical beam splitter between the laser source and the optical switch network.

In ninth examples, for any of the eighth examples the receiver comprises N receiver blocks, and each of the receiver blocks comprises a local oscillator tap coupled to one output of the beam splitter and a polarization splitter coupled to an input of one of the 1:M switches.

In tenth examples, for any of the first through ninth examples the laser source is a first laser source and further comprising a second laser source. The first and second laser sources emit at a same center wavelength and the first and second laser sources are both optically coupled to the optical switch network.

In eleventh examples, for any of the first through tenth examples the laser is a semiconductor laser, the optical switch network, and the output couplers are on a single PIC die.

In twelfth examples an apparatus comprises a frequency modulated continuous wave (FMCW) reflectometry transceiver. The FMCW transceiver comprises an array of M optical output couplers and M is an integer number not less than two. The FMCW transceiver comprises a laser source, a receiver optically coupled between the laser source and the array of output couplers, and an optical switch network coupled between the receiver and the array of output couplers. The optical switch network comprises one input port optically coupled to the laser source and M output ports optically coupled to individual ones of the output couplers. The apparatus comprises CMOS circuitry coupled to the FMCW reflectometry transceiver.

In thirteenth examples, for any of the twelfth examples the switch network is to optically couple the input port to a single one of the M output couplers in a time divided manner.

In fourteenth examples, for any of the twelfth through thirteenth examples the switch network is one of a plurality of first switch networks. The FMCW reflectometry transceiver further comprises a second switch network optically coupled between the receiver and the laser source. The second switch has a number of output ports that is equal to the number of first switch networks.

In fifteenth examples, for any of the fourteenth examples each of the first switch networks comprise a first cascaded Mach-Zehnder interferometer (CMZI) structure.

In sixteenth examples, for any of the fifteenth examples the second switch network also comprises a second CMZI structure.

In seventeenth examples, for any of the sixteenth examples the first CMZI structures are more polarization independent than the second CMZI structure.

In eighteenth examples, a frequency modulated continuous wave (FMCW) reflectometry transceiver system comprises a plurality of optical output couplers, each of the output couplers to transmit optical power off the PIC and to receive reflected optical power back into the PIC. The FMCW reflectometry transceiver system comprises a receiver to detect the reflected optical power, and an optical switch network coupled between a plurality of output couplers and the receiver. The optical switch network comprise a plurality of first ports coupled to individual ones of the plurality of output couplers, and a second port coupled to the receiver. The optical switch network is to couple each of the output couplers to the receiver in a time divided manner.

In nineteenth examples, for any of the eighteenth examples the FMCW reflectometry transceiver system comprises a laser source, wherein the receiver is coupled between the laser source and the optical switch network.

In twentieth examples, for any of the eighteenth through nineteenth examples the receiver comprises a polarization splitter coupled to the second port, a local oscillator tap coupled between the polarization splitter and the laser source, a coherent mixer coupled to an output of the polarization splitter and the local oscillator tap, and a balanced photodetector coupled to an output of the coherent mixer.

It will be recognized that principles of the disclosure are not limited to the embodiments so described, but instead can be practiced with modification and alteration without departing from the scope of the appended claims. The above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. An apparatus, comprising:
a laser source to output a beam;
a plurality of optical output couplers, each of the output couplers to propagate the beam away from the coupler and to collect optical power reflected back toward the coupler;
a receiver to detect the reflected optical power; and
an optical switch network coupled between the output couplers and the receiver, wherein the optical switch network comprise a plurality of first ports, each of the first ports optically coupled to one of the output couplers, and a second port optically coupled to the receiver, wherein the switch network is to optically couple each of the first ports to the second port in a time divided manner.

2. The apparatus of claim 1, wherein the optical switch network comprises a cascaded Mach-Zehnder interferometer (CMZI) structure comprising a first MZI structure in serial cascade with a second MZI structure.

3. The apparatus of claim 2, wherein the first and second MZI structures comprise polarization independent optical waveguides.

4. The apparatus of claim 1, wherein the receiver comprises a polarization splitter coupled to the second port.

5. The apparatus of claim 4, wherein the receiver comprises:
a local oscillator tap coupled between the polarization splitter and the laser source;
a coherent mixer coupled to an output of the local oscillator tap and an output of the polarization splitter; and
a balanced photodetector coupled to an output of the coherent mixer.

6. The apparatus of claim 5, wherein the receiver comprises a single polarization splitter and a single local oscillator tap.

7. The apparatus of claim 6, wherein the beam comprises a plurality of center wavelengths, and
wherein the receiver comprises a plurality of resonant ring filters, each tuned to a different one of the plurality of center wavelengths.

8. The apparatus of claim 1, wherein:
the plurality of output couplers comprises N sets of M output couplers and N and M are each an integer number greater than one;
the optical switch network comprises N 1:M switches; and
further comprising a 1:N optical beam splitter between the laser source and the optical switch network.

9. The apparatus of claim 8, wherein the receiver comprises N receiver blocks, and each of the receiver blocks comprises a local oscillator tap coupled to one output of the beam splitter and a polarization splitter coupled to an input of one of the 1:M switches.

10. The apparatus of claim 1, wherein the laser source is a first laser source and further comprising a second laser source, wherein the first and second laser sources emit at a same center wavelength, and wherein the first and second laser sources are both optically coupled to the optical switch network.

11. The apparatus of claim 1, wherein the laser is a semiconductor laser, the optical switch network, and the output couplers are on a single photonic integrated circuit (PIC) die.

12. An apparatus, comprising:
a photonic integrated circuit (PIC), comprising:
an array of M optical output couplers, wherein M is an integer number not less than two;
a laser source;
a receiver optically coupled between the laser source and the array of output couplers; and
an optical switch network coupled between the receiver and the array of output couplers, the switch network comprising one input port optically coupled to the laser source and M output ports optically coupled to individual ones of the output couplers; and
CMOS circuitry coupled to the PIC.

13. The apparatus of claim 12, wherein the switch network is to optically couple the input port to a single one of the M output couplers in a time divided manner.

14. The apparatus of claim 12, wherein the switch network is one of a plurality of first switch networks and wherein the FMCW reflectometry transceiver further comprises a second switch network optically coupled between the receiver and the laser source, the second switch having a number of output ports that is equal to the number of first switch networks.

15. The apparatus of claim 14, wherein each of the first switch networks comprise a first cascaded Mach-Zehnder interferometer (CMZI) structure.

16. The apparatus of claim 15, wherein the second switch network also comprises a second CMZI structure.

17. The apparatus of claim 16, wherein the first CMZI structures are more polarization independent than the second CMZI structure.

18. An apparatus, comprising:
a plurality of optical output couplers, each of the output couplers to transmit optical power off the PIC and to receive reflected optical power back into the PIC;
a receiver to detect the reflected optical power; and
an optical switch network coupled between a plurality of output couplers and the receiver, wherein the optical switch network comprise a plurality of first ports coupled to individual ones of the plurality of output couplers, and a second port coupled to the receiver, wherein the optical switch network is to couple each of the output couplers to the receiver in a time divided manner.

19. The apparatus of claim 18, further comprising a laser source, the receiver coupled between the laser source and the optical switch network.

20. The apparatus of claim 19, wherein the receiver comprises:
a polarization splitter coupled to the second port;
a local oscillator tap coupled between the polarization splitter and the laser source;
a coherent mixer coupled to an output of the polarization splitter and the local oscillator tap; and
a balanced photodetector coupled to an output of the coherent mixer.
